(19) United States
(12) Patent Application Publication
(10) Pub. No.: US 2019/0205587 A1
(43) Pub. Date: Jul. 4, 2019

(54) METHOD AND APPARATUS FOR CONDUCTING OFFLINE COMMERCE TRANSACTIONS USING AN ENCRYPTED USER ID BARCODE

(71) Applicant: Marvin T. Ling, Scottsdale, AZ (US)

(72) Inventor: Marvin T. Ling, Scottsdale, AZ (US)

(21) Appl. No.: 16/326,748

(22) PCT Filed: Aug. 25, 2016
(86) PCT No.: PCT/US16/48576

§ 371 Date: Feb. 20, 2019

(51) Int. Cl. G06K 7/14; G06Q 20/20; G06Q 20/40

(52) U.S. Cl. CPC G06K 7/1413; G06Q 20/204; G06Q 2220/00; G06K 7/1456; G06Q 20/4033

(57) ABSTRACT

A person conducting offline commerce transaction provides a number that uniquely identifies the person, such as a credit card number, cell phone number, or other number. That number is converted into a dual barcode comprising a first barcode and a second barcode. Each barcode comprises a predetermined standard number of digits to render them compatible with standardized barcode readers available at most retail and commercial establishments. The person's barcode number is encrypted by an encryption algorithm selected by an index located in the first barcode. The person's barcode is rotated before or after encryption and the resulted encrypted User ID Barcode is placed in the second barcode. The first and second barcodes contain the standard number of digits with one of the digits provided with a unique symbol distinguishing the first and second barcodes from each other and from barcodes that are associated with products that may be scanned during a commercial transaction using the User ID Barcode.

### RELATED APPLICATIONS

This application is related to application Ser. No. 13/816,955 published under Publication No. US-2013-0140361-A1 entitled “METHOD AND APPARATUS FOR CONDUCTING OFFLINE COMMERCE TRANSACTIONS”, now U.S. Pat. No. 9,280,689, and application Ser. No. 14/401,998 published under Publication No. US-2015-0142672-A1 entitled “METHOD AND APPARATUS FOR CONDUCTING OFFLINE COMMERCE TRANSACTIONS”.

### FIELD OF THE INVENTION

The present invention relates to methods and apparatus for conducting offline commerce transactions using the User ID Barcode as the user identifier for purchasing goods priced at micro payment or non-micro payment level using the fund or credit limit available in the user's account in the server identified as a User Vendor Management Server (UVM).

The User ID Barcode is defined as the barcode generated from any number that uniquely identifies a user, such as credit card number, cell phone number, driver's license number or other numbers. The User ID Barcode indicated above may be expanded to include Country Code, Company Code, User Index and User ID. The County Code allows the user to make purchases of goods at any participating vendors worldwide. The company code allows any company, such as cell phone companies or large retail companies to issue the User ID Barcode in additions to banks or credit card companies. Furthermore, in order to increase the security, the User ID Barcode will have a User Index which points to the large list of encryption algorithms used to encrypt the User ID. A prefixed special character “?” is used in order to distinguish the User ID Barcode from bar codes representing products.

Three types of the User ID Barcode are described. The Type One User ID Barcode incorporates 11 digit barcode, the Type Two User ID Barcode consists of one 11 digit barcode, having encrypted User ID, and Type Three User ID Barcode incorporates two 11 digit barcodes.

### BACKGROUND OF THE INVENTION

Users (purchasers) use coins or cash for the payment of purchases of low cost goods at the present time. It is very inconvenient for users to carry coins or cash. Furthermore, it takes time for the cashier at the cash register to count change for users. For payment of purchases in regularly priced goods, users usually are not too concerned with the time it takes to complete the purchasing transactions. However, users generally do not have patience to wait for and to complete the payment at the cash register for purchasing of goods costing at micro payment level.

Additionally, credit card companies generally would prefer not to honor purchasing transactions in micro payment made by users. This is because the cost of the transaction processing is too high to justify allowing users to make payment using the credit card for their purchasing transactions in micro payment amount. However, the credit card companies do allow their users to charge purchasing in micro payment amount in order to provide better services, avoid adverse publicity for refusing payment, and customer satisfaction.

With the prevalence of cell phones in everyday life, users now use their cell phones to purchase a variety of digital content ranging from ring tones, music, videos, games, new articles, maps, and apps. However, there was no easy and effective method to process off line micro payment transactions using a cell phone. Yet, vendors, users and cell phone service providers all realize that the market requires such a solution. Several cell phone service provider companies have introduced new cell phones enabling users to make contactless payment for purchases at vendor sites. These cell phones require a built in proprietary IC chip utilizing Near Filed Communication (“NFC”) technology, or have attached an NFC chip on the back of the cell phone. Recently, retail stores have promoted the use of cell phone with built in NFC for payments of purchases.

The use of NFC technology requires the vendor to adopt proprietary hardware in an NFC receptor to allow for the reduction of the cost of the user's purchase from the amount of pre-funded deposits by the users that is stored within the NFC. Such hardware adoption is very difficult to gain mass vendor acceptance. Any upfront capital costs to a vendor, especially small vendors, only meets with resistance creating a significant barrier to entry.

While the NFC provides users the convenience for transacting their purchases very quickly, it nonetheless does not account for security issues such as in the case of loss of the cell phone where the remaining amount of funds deposited by the user are still within the cell phone NFC. It is like a lost wallet containing cash. Furthermore, when the amount of money inside the cell phone NFC is running out, the user is required to add more money into the NFC using a special machine available only in at limited places within banks or other public places. This is inconvenient for the customer.

One potential problem for the cell phone company providing products with the NFC chip to their customers is that the company does not have the customer's purchasing transaction data. This means the company does not receive profit from each and every purchase that the customer makes at the vendor sites using the cell phone with NFC chip. This is contrary to customer's use of credit card in which the credit card company receives vendor service fees from the vendor where the customer made the purchase. Furthermore, the lack of customer's transaction data means the company supplying products with NFC chip will not have the information which is vital for market studies and strategic planning. Therefore, the major advantage that the company supplying their customers cell phones with built in NFC chip is that it may potentially attract more customers than companies supplying cell phones without the NFC chip.

Several years ago, a “cell phone wallet” was introduced. The cell phone wallet has a built in IC chip using a proprietary technology. Similar to cell phones with built-in NFC, the cell phone wallet also requires the user to add money using a special machine which is only available in a limited number of locations. Vendors also require a proprietary chip reader to subtract the total amount the user purchased to complete the purchasing transaction.

A global standard for inter-operation of integrated circuit cards (IC cards or “chip cards”) and IC card capable point of sale (POS) terminals has been established. It is a joint effort to ensure security and global interoperability so that designated credit cards can continue to be accepted everywhere. The IC card does allow the user to pay for goods in micro payment, similar to cell phones with NFC chip. The potential market for the credit card with built-in IC chip or NFC chip is again for micro payment of offline purchases.

### SUMMARY OF THE INVENTION

The User ID Barcode introduced herein may require more than 11 digits; however, the scanner available with the cash registers in stores can capture only 11 digit total. That is because the product barcode of the product being purchased is displayed in 10 digits, usually in two 5 digits pairs separated by a blank character. Therefore the user ID Barcode must be made with 11 digits numbers or two 11 digits numbers. For two 11 digits number barcodes, the cashier needs to use the scanner twice to capture the entire barcodes.

The present invention provides a selection of User ID Barcode types to be made available for use in a purchasing transaction including Type One User ID Barcode that has 11 digits including 10 digits User ID with a leading special character “?”, the User ID has no encryption therefore the type one User ID Barcode has no security. Type Two User ID Barcode includes 11 digits, the first digit is the special character, “*”, indicating the Type Two User ID, followed by 2 digits encryption code and 8 digits User ID. The Type Three User ID Barcode includes two 11 digit barcodes. The first 11 digit barcode of the Type Three includes a leading special character, “#”, followed by 3 digits Country Code, 3 digits Company Code, 2 digits Rotation Code and 2 digits encryption code. The second 11 digit barcode of the Type Three includes a leading special character “=” followed by 10 digits encrypted User ID.

The User ID Barcodes introduced here are secured to a supporting media and may be downloaded into a cell phone to be viewed on the phone display, making the cell phone a Cell Phone wallet, or may be printed on the back of a credit card or a new plastic card, or on a label secured to the back surface of a cell phone or other supporting media.

The Rotation Code is an encryption code modifier and is introduced here to rotate the User ID right or left before or after encryption. Other encryption code modifiers may be used, but the Rotation Code is simple and compact and provides additional security while being flexible in its use. The Rotation Code It also provides rotation either right or left before encryption and again after encryption to provide additional security for the User ID Barcode. To obtain the User ID Barcode, the Rotation Code is performed in reverse order. A list of encryption algorithms is introduced here in a table. It is to be noted that the decryption for the encrypted User ID is to apply the same encryption algorithm to the encrypted User ID.

A User Vendor Management System Server (herein after referred to as UVM) creates the User ID Barcode for a registered user and downloads it to the user's cell phone or printed on a plastic or other supporting media for the user. The UVM may decide to use Type One or Type Two or Type Three User ID Barcode for the registered user.

The UVM will apply the rotation code in reverse manner and decrypt the Type Three User ID Barcode to obtain the actual User ID before processing the User's purchasing transaction and record the transaction data into the User's data base. The vendor's data base is also updated for the purchasing transaction made by the user. The Rotation Code and Encryption Table are maintained by the UVM.

### BRIEF DESCRIPTION OF THE DRAWINGS

The present invention may more readily be described by reference to the accompanying drawings in which:

FIG. 1 is an illustration of the Type One User ID Barcode without encryption;

FIG. 2 is an illustration of the Type Two User ID Barcode with an encryption index;

FIG. 3 is an illustration of the Type Three User ID Barcode with two 11 digit barcodes, the first barcode contains the Country code, the Company code, the Rotation Code and Encryption Index which specifies the encryption algorithm; the second barcode is the resulting encrypted User ID;

FIG. 4 is an illustration of the off line purchasing system using the User ID Barcode for the payment of purchase;

FIG. 5 is an illustration of the offline commerce transaction using the system of the present invention; and

FIG. 6 is an illustration of a payment system incorporating the present invention and useful to describe the operation of the system.

### DETAILED DESCRIPTION OF THE INVENTION

The User ID Barcode identifies the user and provides the user a convenient means to make the payment for the purchase of goods. A barcode, as used herein, refers to the typical optical machine-readable representation of data. The code usually identifies data concerning the object to which it is attached and is represented by varying widths and spacing of parallel lines. The data contained in the barcode is read by conventional barcode readers or scanners typically used in most retail establishments that optically recognize the spacing and width of the parallel lines to derive data concerning the article to which the code is attached.

The User ID Barcode is generated from a number that uniquely identifies a user. The user's cell phone number or the credit card number or other number that can uniquely identify the user may be chosen as the unique number. The UVM may have its own method for assigning the number to the registered user. This unique number is referred to as the User ID. The system described herein provides a selection of three types of the User ID Barcodes. The Type One User ID Barcode is a barcode with a special character “?” followed by a 10 digit User ID. The Type Two User ID Barcode is a barcode with a special character “*” followed by 2 digit encryption code and 8 digit User ID. The Type Three User ID Barcode consists of two 11 digit numbers. The first 11 digit number includes a leading special character “a” followed by 3 digit Country Code, 3 digit Company Code of the company that issued the User ID Barcode, 2 digit Rotation Code and 2 digit encryption index which specifies the encryption algorithm within the encryption table. The second 11 digit number has the “=” as the leading special character followed by 10 digit encrypted User ID.

The encryption algorithm used for a user's User ID Barcode is different from that of another person. Therefore, the encryption algorithm is “user variant”. The encryption algorithm can be changed with time to provide additional level of security for the user. Therefore the encryption algorithm is also “time variant”.

For the purchasing transaction processing, the UVM will receive the transaction data from the Vendor Server. The transaction data includes such information as Vendor ID, Cash Register number, list of products the user purchased, the total amount of the purchase and the User ID Barcode.

The transaction data is sent to the UVM through the Vendor Server. The Vendor Server contains a list of products for sale with each product description, name and its barcode. The Vendor Server may also have product suppliers information and inventories. Large companies may have their own Vendor Server. Some very large companies with international presence provide Vendor Server for vendors without their own Vendor Server.

When the Type Three User ID Barcode is selected, upon receiving the transaction data, the UVM will apply Rotation Code in reverse and decrypt the User ID Barcode. To decrypt the User ID Barcode, the UVM applies the same decryption algorithm as specified by the encryption index within the User ID Barcode. Note that applying the decryption algorithm to a User ID Barcode will result in the original User ID. The UVM maintains the Rotation Code and the entire Encryption Table.

After decrypting the User ID Barcode, the UVM accesses the user's data base and subtracts the amount of “Available Fund” equivalent to the total purchasing price and sends the “Approved” signal back to the vendor through the Vendor Server. Note that the transaction data includes the Cash Register number allowing the Vendor Server to direct the “Approved” message to the correct cash register in the vendor site and that completes the purchasing transaction. If the user does not have the enough funds available in the user's UVM account, the system sends a “Rejected” signal back to the cash register.

One of the key features of the present invention is the rapidity with which the purchasing transaction is made by the user using the User ID Barcode. The user usually has little concern with the time it takes to complete the payment for the purchase of regularly priced goods at the cash register while the user will have little patience to wait for the completion of payment process for purchasing goods that is in micro payment level. The present system provides fast checkout with the cashier and therefore provides the user with convenience while potentially allowing the vendor to reduce the number of cashiers to therefore reduce the vendor's operation cost. The system of the present invention will have one or more Web Servers which accept the time consuming user input for the user registration and the login functions, allowing the UVM to focus on processing the purchasing transactions and provide fast response for completion of the purchasing transaction processing. The number of Web Servers required is determined by the degree of heavy traffic for large numbers of users performing registration or login to the UVM. In addition, in order to achieve a fast response from the UVM, the UVM may defer the user's data base update at a later time. Multiple numbers of UVMs can be operated in case there are many registered users in an UVM operating company and the proper UVM in which the user information is stored can be identified by the first few digits of the user's decrypted User ID. This allows faster access for the user's data base.

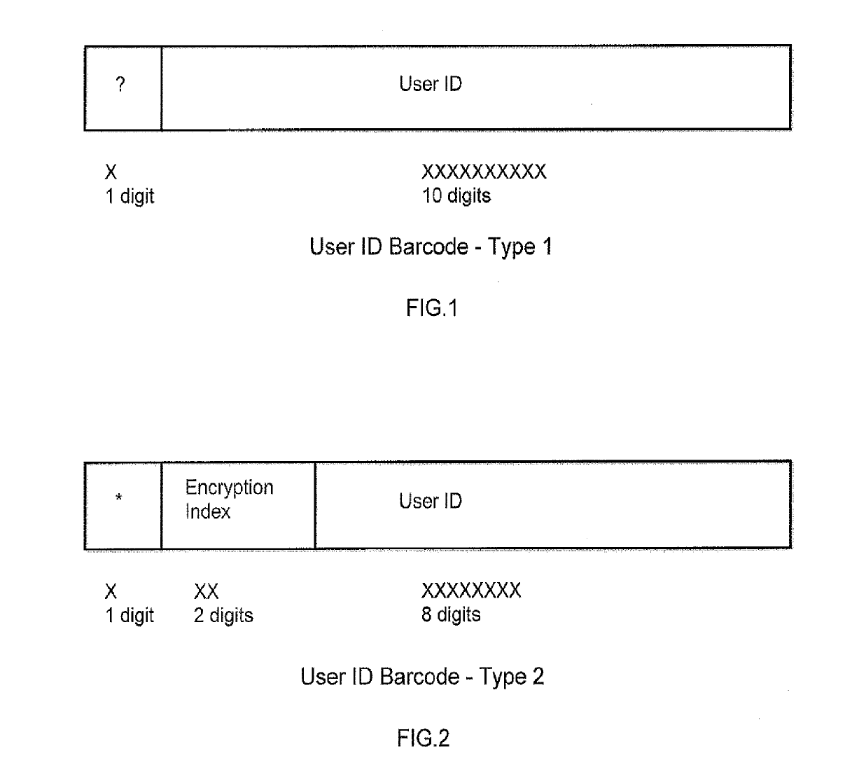

With reference to FIG. 1, the User ID is shown in User ID Barcode format. The “?” indicates that the barcode is a User ID Barcode not a product barcode. This special character may be known as “User ID Barcode Identifier” which term will be used herein. The User ID Barcode Identifier is followed by 10 digits User ID. The User ID Barcode shown in this FIG. 1 is simple, however it has no security and it may not be appropriate for actual use by customers.

FIG. 2 shows the 11 digits User ID with encryption. The first digit is the User ID Barcode Identifier “*” followed by 2 digits Encryption Index which specifies the encryption algorithm used to encrypt the 8 digits User ID that follows. Due to 8 digits User ID, the total number of users is limited to 10 million.

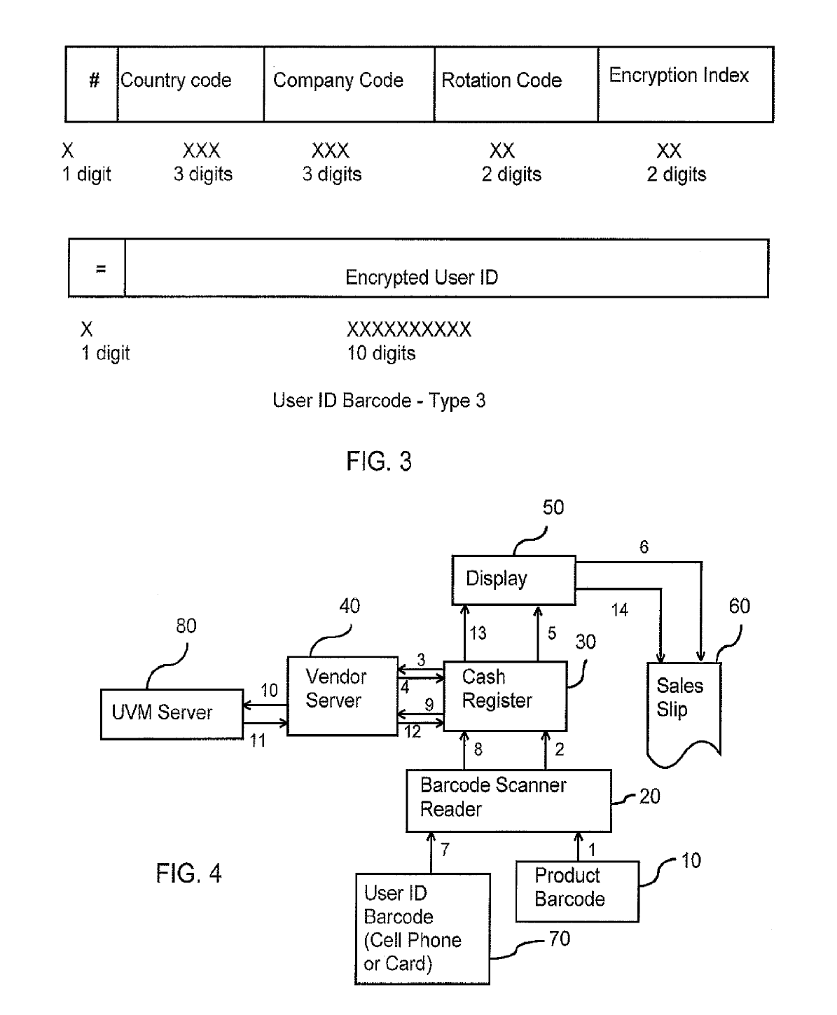

Referring to FIG. 3, the User ID Barcode is shown as a dual barcode; that is, it has two 11 digit barcodes. The two barcodes are interdependent and provide necessary information for the commercial transaction while permitting variable encryption wherein data in one of the 11 digit barcodes provides a modification code for the encryption contained in the second 11 digit barcode. The first of the two 11 digit barcodes provides an encryption index for the encryption algorithm to be utilized in the second 11 digit barcode and also contains an encryption modifier such as a rotation code. The first 11 digit barcode contains the User ID Barcode Identifier “#”, followed by a 3 digit Country Code, 3 digit Company Code, followed by 2 digit Rotation Code and 2 digit Encryption Index which indicates the specific encryption algorithm as described in the Encryption Table. The second 11 digit barcode contains “=” User ID Barcode Identifier followed by a 10 digit encrypted User ID.

TABLE 1
Rotation Code

11, 12------18, 19 Rotate Right before encryption---------1, 2 through 9 digits
11, 22------28, 29----- Rotate Right after encryption-------------1, 2 through 9 digits
31, 32------38, 39------Rotate Left before encryption------------1, 2 through 9 digits
41, 42------48, 49------Rotate Left after encryption --------------1, 2 through 9 digits
51, 52------58, 59------Rotate Right before encryption and Rotate Right after encryption--------1, 2 through 9 digits
61, 62------68, 69------Rotate Right before encryption and Rotate Left after encryption-----------1, 2 through 9 digits
71, 72------78, 79-------Rotate Left before encryption and Rotate Left after encryption------------1, 2 through 9 digits
81, 82------88, 89------Rotate Left before encryption and Right after encryption-------------------1, 2 through 9 digits

Table 1 above shows a summary of the Rotation Code used as an encryption modifier. The first digit is the command, 1 for Rotate Right, before encryption and 2 for Rotate Right after encryption, 3 for Rotate Left before encryption and 4 for Rotate left after encryption. The second digit specifies the number of digits the rotation as specified is to perform. Next, the first digit 5 is the command to Rotate Right before and after encryption. The command 6 is to Rotate Right before encryption and Rotate Left after encryption. The command 7 is to Rotate Left before and after encryption and finally, the command 8 is to Rotate Left before encryption and Rotate Right after encryption.

The Rotation Code Summary in Table 1 shows the same number of digits for rotation before and after encryption however no such restriction is necessary. For example, the system may rotate right 3 digits before encryption and rotate left 7 digits after encryption. The reverse will be to rotate right 7 digits before decryption and rotate left 3 digits after decryption to obtain the actual User ID. In this embodiment, the total number of different rotation specifications will exceed 400 and the Rotation Code then becomes a Rotation Index specifying the rotation code within the Rotation Code Table. The Rotation Index would require 3 digits. The adjustment can be made by reducing either the Country code or the Company Code to 2 digit Codes to accommodate extra digit required for the Rotation Index. The UVM maintains the Rotation Code Table.

Referring to Table 2, examples of encryption algorithm used for the encryption of the USER ID before converting to the barcode format is shown:

TABLE 2
Encryption Table

| | |
|---|---|
| Encryption Number | User ID -------0123456789 |

| | | |
|---|---|---|
| 11 | SW 12 1 | 1023456789 Switch the 1^{st} and 2^{nd} digit and switch the next |
| 12 | SW 12 2 | 1032456789 two digits the number of times as indicated by |
| 13 | SW 12 3 | 1032546789---the third digit. |
| 14 | SW 12 4 | 1032547689 |
| 15 | SW 12 5 | 1032547698 |

| Encryption Number | User ID 0123456789 | |
|---|---|---|
| 35 | SW 13 46 78 | 2105437689---Switch 1^{st} and 3^{rd} digits, 4^{th} and 6^{th} digit 7^{th} and 8^{th} digit. |
| 36 | SW 13 46 79 | 2105438769---Switch 1^{st} and 3^{rd} digits, 4^{th} and 6^{th} digits 7^{th} and 9^{th} digit. |
| 37 | SW 13 46 710 | 2105439786---Switch 1^{st} and 3^{rd} digits, 4^{th} and 6^{th} digits 7^{th} and 10^{th} digits |

These are examples of the Encryption Tables of encryption algorithms which are maintained by the UVM.

A person wishing to conduct offline electronic commerce transactions at vendors having barcode scanners or readers, such as conventional retail stores and the like, may apply to a UVM to obtain a User ID Barcode for use in such transactions. The person would provide the UVM with a personal code which may be a credit card number, a cell phone number, a driver's license number or similar unique personal code. The UVM then converts this personal code into a User ID Barcode in the form of a dual barcode, each of the dual barcodes comprising 11 digit barcodes corresponding to the typical and standard 11 digit barcodes used in retail establishments to identify products when purchasing transactions occur. The first barcode includes a leading special character “#” followed by a 3 digit country code and a 3 digit company code. The UVM selects a Rotation Code and an Encryption Index each requiring 2 digits of the first of the dual barcodes. The personal code is then encrypted by the chosen encryption algorithm identified by the Encryption Index; the personal code may be modified in accordance with the rotation code before or after encryption. The encrypted User ID is then placed in the second of the dual barcodes and provided with a different special character “=”.

When the commercial transaction or purchase is being performed, the clerk at the Vendor's cash register uses the standard barcode reader and successively reads the first and the second barcodes.

Referring to FIG. 4, an illustration of a purchasing transaction using the User ID Barcode, as displayed in a cell phone window or printed in the back of a credit card.

The product barcode 10 being purchased is captured using a Barcode Scanner Reader 20, step 1, and it is sent, step 2, through Cash Register 30 to the Vendor Server 40, step 3. The Vendor Server 40 sends the description of the product including the price back to the Cash Register 30, step 4 and it is displayed at the cash register Display 50, step 5 and it is printed in the Sales Slip 60, as shown in step 6. When all purchased products are entered at the cash Register 30, the user is asked to make the payment. The user shows the User ID Barcode as displayed in the cell phone or as printed in the back of the credit card to the cashier. The cashier captures the User ID Barcode 70, using the Barcode Scanner Reader 20, step 7. When the UVM has been programmed to select the dual barcode (Type 3 User ID Barcode) the cashier utilizes the barcode scanner reader to capture the two 11 digit barcodes of the dual barcode. The Cashier scans one barcode after another of the two barcodes.

The barcode scanner sends the User ID Barcode it captured to Cash Register 30, step 8, and the Cash Register 30 sends the transaction data which includes the vendor ID, the product description, the total purchasing amount, the User ID Barcode and other information to the Vendor Server 40, step 9. The Vendor Server 40 detects the special character in the barcode (User ID Barcode Identifiers) indicating that the barcode does not represent any products for sale and it is the User ID Barcode. The Vendor Server 40 sends the User ID Barcode together with the transaction data to the UVM server 80, step 10.

The UVM retrieves the User's UVM account and check to see if the user has sufficient funds in the user's UVM account. If yes, the UVM Server 80 subtracts the total cost of the user's purchases from the user's UVM account and sends the approved signal back to the Vendor Server 40, step 11, to the Cash Register 30, step 12. The Cash Register 30 displays the approval signal, step 13 and prints out the Sales Slip 60 as shown in step 14. This completes the purchasing transaction. If the user does not have sufficient funds in the user's UVM account or if there is any problem with the user's UVM account, the UVM Server 40 sends the rejection signal to the Cash Register 30 and the transaction is canceled.

The above process requires that the Vendor Server 40 detect the User ID Barcode Identifier to transfer User ID Barcode, transaction data and other information to the UVM Sever 40. This requires that the Vendor Server 40 be modified to include such detection logic. The operator of the Vendor Server 40 may prefer not to have any change or modification to the Vendor Server. In such case, a Web Server can be installed between the Cash Register 30 and the Vendor Server 40 as shown in FIG. 5.

Referring to FIG. 5, the Web Server 90 checks all barcodes it receives from the Cash register 30. If the barcode is a product barcode, it passes the barcode to the Vendor Server 40, step 3 and the process continues as described in FIG. 4. If the Web Server 80 detected the User ID Barcode Identifier in the barcode it received, the Web Server 90 sends the User ID Barcode together with the transaction data and other information from the Server 40, step 4, to the UVM 80, step 10. The UVM processes the transaction data and sends through the Web Server 90 in step 11 the “Approved” or “Rejected” back to the Cash Register 30, step 12 depending on if the User has enough fund in the UVM account to cover the total cost of the purchases, and the Cash Register 30 displays the “Approved” or “Rejected” message in step 13 and print out step 14 the Sales Slip 60 as shown and that completes the purchasing transaction.

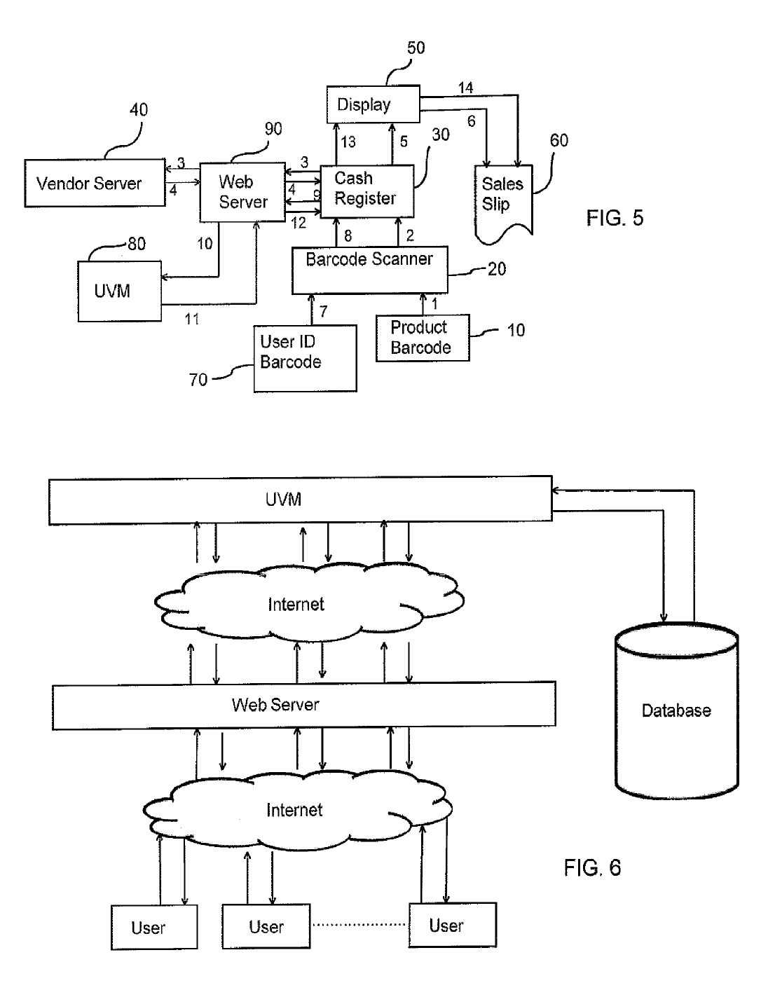

FIG. 6 describes the present system in a multi Web Server environment. There are multiple numbers of Web Servers which accept users to register and/or login to the UVM. The system provides one URL address and it directs the user to any one of multiple web servers that is ready to accept user's input, allowing the user to enter ID and Password to register or login. Having multiple web servers provides convenience to users because a user may take relatively longer time then others to input ID and Password for registration or login. Also, some users take extra time to input the User ID and Password due to typo errors and the like. The wrong ID that may be inputted may include “ID not found”, or “ID already exists” in case the user wants to create its own User ID and Password. Also for a registered user, the password the user entered my be wrong and requires the user to make the correction. Note that web servers and the UVM access the same data base.

Assigning this man-machine interface tasks for the user's input to the web server avoids the user taking time from the UVM. The web server sends the user's input data to the UVM upon user's successful completion of the input. By separating the user's input tasks to web servers, permits the UVM to focus on purchasing transaction processing, and to send the “Approved” or “Rejected” message back to the vendor cash register as soon as possible. Again, fast response time is important for the customer satisfaction and vendor work efficiency.

The UVM operating company may operate multiple numbers of UVMs in case there are many registered users in an UVM operating company. In that case, it is desirable that the UVM assign the newly registered user the User ID with first 1 or 2 digits corresponding to the proper UVM in which the user information is stored. This avoids the UVM looking for the UVM server in which the user information is stored.

The UVM system operator, the company indicated by the Company Code, settles with each vendor upon reaching the predetermined amount or the time whichever comes first.

What is claimed is:

1. In a system for conducting offline electronic commerce transactions having a vendor barcode scanner for scanning product barcodes, said barcodes having a predetermined number of digits and having a barcode identifier digit indicating the barcode as a product identifier, the improvement comprising:
(a) a User ID Barcode secured to a supporting media to be scanned by said barcode reader;
(b) said User ID Barcode comprising a dual barcode for identifying a user including a first and a second barcode each having said predetermined number of digits and each having a different barcode identifier digit to identify the barcodes as the first barcode and the second barcode, respectively, of said User ID Barcode;
(c) said first barcode having an encryption index defining which encryption algorithm of a plurality of algorithms was chosen for encryption of a User ID, and an encryption modifier code for modifying the User ID encrypted by said algorithm; and
(d) said second barcode having said User ID encrypted by said chosen algorithm and modified by said modifier code.

2. The system for conducting offline electronic commerce transactions of claim 1 wherein said first barcode includes a Country Code and a Company Code.

3. The system for conducting offline electronic commerce transactions of claim 1 wherein said encryption modifier code is a rotation code.

4. In a system for conducting offline electronic commerce transactions having a vendor barcode scanner for scanning product barcodes, said barcodes having a predetermined number of digits and having a barcode identifier digit indicating the barcode as a product identifier, the improvement comprising:
(a) a User ID Barcode secured to a supporting media to be scanned by said barcode reader;
(b) said User ID Barcode comprising a dual barcode for identifying a user including a first and a second barcode each having said predetermined number of digits and each having a different barcode identifier digit to identify the barcodes as the first barcode and the second barcode, respectively, of said User ID Barcode;
(c) said first barcode having an encryption index identifying which encryption algorithm of a plurality of algorithms was chosen for encryption of a User ID, and a rotation code for modifying the User ID encrypted by said algorithm by rotating the User ID right or left; and
(d) said second barcode having said User ID encrypted by said chosen algorithm and modified by said modifier code.

5. The system for conducting offline electronic commerce transactions of claim 4 wherein said rotation by said rotation code occurs before or after encryption.

6. A method for conducting offline electronic commerce transactions at a vendor cash register having a vendor barcode scanner for scanning barcodes having a predetermined number of digits, comprising:
(a) receiving a personal code from a person for their use to purchase goods;
(b) establishing an account for the person to receive funds and to disburse funds for subsequent purchases;
(b) converting said personal code into a dual barcode format to form a User ID Barcode, said User ID Barcode corresponding to said personal code and including a first and a second barcode each having said predetermined number of digits and each having a different barcode identifier digit to identify the barcodes as the first barcode and the second barcode, respectively, of said User ID Barcode;
(c) scanning said User ID Barcode at a vendor cash register and scanning product barcodes of products to be purchased at said cash register;
(d) transmitting said dual barcode to a User Vendor Management server;
(e) decrypting said dual barcode to derive said personal code; and
(f) determining if sufficient funds are in the person's account and transmitting an approval or rejection of the purchase to the cash register.

7. The method for conducting offline electronic commerce transactions as set forth in claim 6 wherein said converting said personal barcode includes encrypting said personal barcode with an encryption algorithm identified by an encryption index in said first barcode and placing the resulting encrypted personal code in the second barcode.

8. The method for conducting offline electronic commerce transactions as set forth in claim 7 wherein said personal code is modified before or after encryption.

9. The method of conducting offline electronic commerce transactions as set forth in claim 8 wherein said personal barcode is modified by rotating said personal barcode.
